(19) United States
(12) Patent Application Publication
(10) Pub. No.: US 2024/0343615 A1
(43) Pub. Date: Oct. 17, 2024

(54) POLYMER BODIES WITH AMINE OR AMMONIUM ACTIVATION FOR WATER TREATMENT AND WATER TREATMENT PROCESS USING THESE

(71) Applicant: CHEMRA GmbH, Trier (DE)

(72) Inventor: Rudolf WEINAND, Trier (DE)

(73) Assignee: CHEMRA GmbH, Trier (DE)

(21) Appl. No.: 18/700,084

(22) PCT Filed: Oct. 12, 2022
(86) PCT No.: PCT/EP2022/078449

§ 371 Date: Apr. 10, 2024

Related U.S. Application Data
(60) Provisional application No. 63/255,800, filed on Oct. 14, 2021.
(60) Provisional application No. 63/302,332, filed on Jan. 24, 2022.
(60) Provisional application No. 63/302,338, filed on Jan. 24, 2022.
(60) Provisional application No. 63/306,398, filed on Feb. 3, 2022.
(60) Provisional application No. 63/306,391, filed on Feb. 3, 2022.

(51) Int. Cl. C02F 1/42; B01J 41/05; B01J 41/14; C02F 101/00; C02F 101/36; C02F 103/28; C02F 103/30

(52) U.S. Cl. CPC C02F 1/42; B01J 41/05; B01J 41/14; C02F 2001/422; C02F 2101/006; C02F 2101/36; C02F 2103/28; C02F 2103/30

(57) ABSTRACT

In general, the invention relates to a process for reducing the content of halogenated organic compounds or complexes with radionuclides in a liquid. The invention further relates to a water treatment plant and the use of a plurality of bodies for treating water and aqueous radioactive waste. The invention relates to a treatment process for preparing a treated liquid, the treatment process comprising the following treatment steps: a. providing a source liquid, the source liquid comprising: i. water at a content of at least 70 wt. %, and ii. one or more X-constituents at a total content of at least 10-10 wt. %, each X-constituent being a halogenated organic compound having 2 or more halogen atoms per molecular unit, or each X-constituent being a complex ion comprising at least one radionuclide; b. providing a plurality of solid M-bodies, each M-body comprising: i. an R-body of one or more R-constituents at a dry weight total content of at least 80 wt. %, each R-constituent being a polymer, ii. first and optionally further N-constituents adjacent to the R-body at a total dry weight content in the range from 0.1 to 10 wt. %, each N-constituent comprising an N atom present as an amine or an ammonium; iii. optionally water at a content of up to 90 wt. %, based on the total weight of the M-body; c. contacting the source liquid with the plurality of M-bodies to obtain the treated liquid, the treated liquid having a lower total content of X-constituents than the source liquid, wherein at least the first N-constituents have one or more L-chains connected to the N atom, each L-chain having a C chain of length 5 or more.

### TECHNICAL FIELD

In general, the invention relates to a process for reducing the content of halogenated organic compounds or complexes with radionuclides in a liquid. The invention further relates to a water treatment plant and the use of a plurality of bodies for treating water and aqueous radioactive waste.

### BACKGROUND

Removal of halogenated organic compounds from water is necessary because halogenated organic compounds can be difficult to break down and have a negative environmental impact. Some particular classes are perchloroalkyl substances and perfluoroalkyl substances (PFAS, also known as PFC), which are synthetic compounds. Some suitable methods are summarised in I. Ross et.al. Remediation J., 28 (2), 1-26.

One method for removing PFAS by adsorption on porous particulate anion exchangers and adsorption resins is disclosed in (A. Zaggia, Water Research 91 (2016) 137-146). Another approach based on a porous activated carbon is presented in WO 2020/037061 A1.

Adsorption and ion exchange materials are contained by housing, such as columns, tube reactors or tanks. The housings and hardware used to host the adsorptions resins or the activated carbon and to perform the water treatment process is known for decades.

Moreover, the ion exchange resins were developed based on the copolymerization of styrene cross-linked with divinylbenzene already in the 1940's. These resins are very stable and have much greater exchange capacities than their predecessors. The polystyrene-divinylbenzene-based anion exchanger can remove all anions, including silicic and carbonic acids. So, the complete demineralization of water possible.

Polystyrene-divinylbenzene resins are still used in the majority of ion exchange applications. Although the basic resin components are the same, the resins have been modified in many ways to meet the requirements of specific applications and provide a longer resin life. One of the most significant changes has been the development of the macroreticular, or macroporous, resin structure.

Standard gelular resins have a permeable membrane structure. This structure meets the chemical and physical requirements of most applications. In addition to polystyrene-divinylbenzene resins, there are newer resins with an acrylic structure, which increases their resistance to organic fouling.

In addition to a plastic matrix, ion exchange resin contains ionizable functional groups. These functional groups consist of both positively charged cation elements and negatively charged anion elements. However, only one of the ionic species is mobile. The other ionic group is attached to the bead structure. Ion exchange occurs when a liquid diffuses into the bead structure and exchange for the mobile portion of the functional group occurs. Ions displaced from the bead diffuse back into the water solution.

Despite all achievements in the area of waste water treatment, the removal of halogenated organic compounds from water remains a challenge, owing to their low capacity to be adsorbed.

Another challenging task is the removal of radionuclides from aqueous liquids, such as treating ground water to drinking water, processing aqueous radioactive waste generated in nuclear power plants, reprocessing plants, nuclear enrichment plants, or from medical facilites. For example, anionic exchange media can be used to remove dissolved uranium complexes like UO₂(CO₃)₂²⁻, UO₂(CO₃)₃⁴ and CaUO₂(CO₃)₃²⁻ from ground water (Schlussbericht zum Verbundprojekt Uranentfernung in der Trinkwasseraufbereitung, December 2009—https://www.dvgw.de/medien/dvgw/wasser/qualitaet/w4_02_04.pdf). Application of ion exchange processes for treatment of radioactive waste is also well established (INTERNATIONAL ATOMIC ENERGY AGENCY, Application of Ion Exchange Processes for Treatment of Radioactive Waste and Management of Spent Ion Exchangers, Technical Reports Series, 2002, chapter 3.3.2.—http://www-pub.iaea.org/MTCD/Publications/PDF/TRS408_scr.pdf). Concepts of application and construction of suited apparatus is also known (see as before: IAEA Technical Report Series, 2002, chapter 4.3).

Despite all achievements in the area of treating aqueous radioactive waste, the removal of these compounds from the aqueous phase remains a challenge, owing to their low capacity to be adsorbed.

### SUMMARY OF THE INVENTION

It is an object of the present invention to provide an improved process for reducing the content of halogenated organic compounds in a liquid, preferably from water.

It is an object of the present invention to provide an improved process for reducing the content of radionuclides and complexes of radionuclides in a liquid, preferably from water.

It is an object of this present invention to provide an improved water processing plant.

It is an object to provide an improved process for the recovery and treatment of fire extinguishing liquids, foams and the like.

It is an object to provide an improved process for the recovery and treatment of liquids originating from the manufacture of textiles and textile impregnation.

It is an object to provide an improved process for the recovery and treatment of liquids originating from the coating and impregnation of paper and carton.

It is an object to provide an improved process for the recovery and treatment of liquids originating from lubricants.

It is an object to provide an improved process for the recovery and treatment of liquids originating from consumer products comprising perfluoroalky substances (PFAS), like ski wax, wood glue and cleaning agents.

It is an object to provide an improved process for the recovery and treatment of sewage sludge, and liquids originating from sewage sludge.

It is an object to provide an improved process for the recovery and treatment of liquid radioactive waste (radwaste).

It is an object of the present invention to provide an improved ion exchange medium for treating a liquid, preferably, preferably for reducing its content of halogenated organic compounds.

It is an object to provide an improved ion exchange medium for the recovery and treatment of fire extinguishing liquids, foams and the like.

It is an object to provide an improved ion exchange medium for the recovery and treatment of liquids originating from the manufacture of textiles and textile impregnation.

It is an object to provide an improved ion exchange medium for the recovery and treatment of liquids originating from the coating and impregnation of paper and carton.

It is an object to provide an improved ion exchange medium for the recovery and treatment of liquids originating from lubricants.

It is an object to provide an improved ion exchange medium for the recovery and treatment of liquid radioactive waste (radwaste).

It is an object to provide an improved ion exchange medium for the recovery and treatment of liquids originating from consumer products comprising perfluoroalky substances (PFAS), like ski wax, wood glue and cleaning agents.

It is an object to provide an improved ion exchange medium for the recovery and treatment of sewage sludge, and liquids originating from sewage sludge.

### Halogenated Organic Compounds (X-Constituents)

The process of the invention reduces the content of halogenated organic compounds in a liquid. Halogenated organic compounds having two or more halogen atoms, referred to herein as X-constituents are preferred. Halogens may be selected from the group consisting of F, Cl, Br & I, preferably selected from F & Cl. In one embodiment an X-constituent contains an F atom, preferably two or more. In one embodiment an X-constituent contains a Cl atom, preferably two or more. In one embodiment an X-constituent contains a Br atom, preferably two or more. In one embodiment an X-constituent contains a I atom, preferably two or more. In one embodiment an X-constituent contains two different halogen atoms, preferably two or more, for example one or more F-atoms, and one or more Cl-atoms; or one or more Cl-atoms, and one or more Br-atoms.

A preferred type of X-constituent comprises a perhalogenate moiety perfluorate or perchlorate moiety. A perhalogenate moiety is preferably a carbon atom fully substituted with halogen atoms. A perhalogenate moiety can be substituted be same or different halogen atoms.

Some preferred X-constituents are prefluoroalkyl substances (PFAS). One particularly preferred category of X-constituents is X*-constituents. An X*-constituent has 20 carbon atoms or less. An X*-constituent preferably has 1 to 20 carbon atoms, more preferably 1 to 10 carbon atoms, more preferably 1 to 7 carbon atoms, more preferably still 1 to 4 carbon atoms.

### Complex Ions Comprising Radionuclides (X-Constituents)

The process of the invention reduces the content of radionuclide organic compounds in a liquid. Examples of radionuclide compounds that can be removed from aqueous media by the process of the invention are dissolved uranium complexes like UO₂(CO₃)₂²⁻, UO₂(CO₃)₃⁴⁻ and CaUO₂(CO₃)₃²⁻.

### B-Constituents

In an embodiment the process of the invention includes a pre-treatment which reduces the content of B-constituents, which are natural organic matter (NOM) and those substances (NOM derivatives) formed in decomposition or fermentation processes from NOM in a liquid, prior to reducing the halogenated organic compounds in a liquid. By choosing a two-step process comprising the pre-treatment and the treatment, the overall efficiency of removal of X-constituents is drastically improved. Besides, the process design of this embodiments allows to dump the solids of the pre-treatment step when exhausted with no particular measures, while the solids exhausted in the treatment step need special care to the load of X-constituents. B-constituents are different from X-constituents.

Natural organic matter (NOM) encompasses a broad range of structurally complex matrix derived from terrestrial eroding and plant or animal tissues degradation. Presented in all surface waters, NOM contributes to the most part of dissolved organic carbon (DOC) in water. As the dominating factor that affects aesthetic quality of water resource (such as color, taste and odor), NOM is the precursor of disinfection by-products (DBPs), a reason of bacterial regrowth in distribution systems, and is implicated in complexation or solubilization of trace metals and pesticides in the aqueous environment.

### M-Bodies (Exchange Media)

The M-bodies of the present invention are preferably adapted and arranged adsorb X-constituents. An M-body comprises a solid structure (R-body) of polymer (R-constituents) with an activating species (N-constituents) adjacent to the R-body.

The N-constituents may be bonded to the R-body via covalent bonds or non-covalent bonds. If an N-constituent is covalently bonded to an R-body, it is adjacent to it as a terminal species. An N-constituent non-covalently bonded to an R-body, it is adjacent to it as a discrete molecule or ion, preferably bonded to it by hydrophobic bonding.

An M-body may be dry or wet. The dry weight contents of the M-body are evaluated without regard to the water. The water content of an M-body is determined as a proportion of the total weight of the wet M-body.

The dry weight content of R-constituents in the M-body is preferably at least 80 wt. %, more preferably at least 90 wt. %, more preferably still at least 95 wt. %.

### R-Bodies and R-Constituents (Polymers)

An R-body of one or more polymers (R-constituents) preferably provides the solid framework of an M-body. The R-body is activated by addition of one or more N-constituents, i.e. a first and optionally further N-constituents, preferably by impregnation or covalent bonding.

An R-body may itself comprise nitrogen atoms within its polymer structure. Such nitrogen atoms are not adjacent to the R-body. Such nitrogen atoms are within the R-body. Such nitrogen atoms do not belong to N-constituents. Some preferred nitrogen atoms which are part of the R-body are amide and cyanide.

A polymer may be a polymer of a single monomer or a copolymer of more than one different monomers. One preferred polymer is a polystyrene, preferably a polystyrene divinyl benzene copolymer. (polystyrene DVB). Other preferred polymers are acrylates and copolymers of acrylate polymers, e.g. polyacrylonitrils. Another preferred polymer is a methacrylate. Another preferred polymer is a phenol formaldehyde resin. Preferred polymers are hydrophobic.

An R-body is preferably porous. An R-body preferably is penetrable by liquid. A preferred R-body has a maximum capacity to soak water up to 10 times its own mass.

An R-body may have pores. Preferred pores are micro pores, meso pores or macro pores. An R-body may have a combination of two or more selected from micro pores, meso pores and macro pores. Micro pores have a pore size of less than 2 mn, meso pores from 2 to 50 nm, and macro pores of more than 50 nm, as defined by IUPAC recommendation (Pure Appl. Chem. 57, (1985)).

One preferred type of R-body is a bead. A bead may be prepared through the agglomeration of smaller particles. A preferred range for the d50 diameter of the R-bodies, or equivalently of the M-bodies, is from 10 μm to 10 mm, preferably from 50 μm to 5 mm, more preferably from 100 μm to 1 mm. Another preferred range for the d50-diameter is from 0.05 to 1.5 mm.

One preferred type of R-body is a powder. A powder may be prepared by grinding a larger particle, preferably by grinding a bead. A preferred range for the d50 diameter of the R-bodies, or equivalently of the M-bodies, is from 1 to 200 μm, preferably from 10 to 100 μm, more preferably from 40 to 60 μm or from 40 to 80 μm.

Preferred grinding processes are dry grinding a wet grinding, preferably wet grinding. Grinding may be performed at atmospheric conditions. Grinding may be performed at elevated temperature, or reduced temperature. On preferred grinding is cryogrinding, preferably with liquid nitrogen. One process for reducing the diameter of R-bodies is a homogenisation, preferably with a hammer mill or with a jet mill.

### N-Constituents

N-constituents are employed for activating R-bodies. Preferred N-constituents according to the invention are amines or ammoniums.

Preferred N-constituents according to the invention have one or more moieties having a carbon chain of length at least 5, herein an L-chain. A chain is a sequence of atoms connected by covalent bonds. The length of the chain is the number of atoms connected by the covalent bonds. A chain can be linear or branched. Further, a chain can be saturated or unsaturated. Saturated defines that all bonds between the chain forming atoms are single bonds. A single bond is a chemical bond between two atoms involving two electrons. Unsaturated defines that at least one bond between any two of the chain forming atoms involves more than two bonding electrons, e.g. four or six. An unsaturated chain may have two or more bonds which involve more than two electrons each. A bond with four electrons is usually referred to as a double bond, with six electrons as a triple bond. Preferred N-constituents could have 1 such L-chain moiety, or 2 such L-chain moieties, or 3 such L-chain moieties. Some preferred L-chain moieties are linear or branched, saturated or unsaturated. Some preferred L-chain moieties are linear and saturated.

Some preferred L-chain moieties may further comprise a functional group. A functional group in this context refers to a chemical group within an L-chain which is different from the atoms forming the chain. Some preferred functional groups are selected from the group consisting of: alkoxy, ester, ketone, aldehyde and carboxylic acid.

Some preferred moieties on an N-constituent are one or more selected from the group consisting of: alkyl, alkene, alkyne, alkoxy, ester, ketone, aldehyde and carboxylic acid.

The N-constituent is preferably present in the M-body at a content in the range from 0.1 to 10 wt. %, preferably 0.5 to 8 wt. %, more preferably 1 to 5 wt. %.

Some preferred L-chain moieties having a carbon chain length of at least 5 are pentalkyl, hexalkyl, heptalkyl, octalcyl, nonalkyl, decalkyl or higher alkyls. Preferred L-chains have 5 to 20 carbon atoms, or 5 to 15 carbon atoms, or 5 to 10 carbon atoms. One preferred N-constituent having a carbon chain length of at least 5 is n-octylamine. Another preferred N-constituent of this kind is cetrimonium chloride.

More than one kind of N-constituents can be employed in the present invention. In this event, reference is made to first N-constituents and further N-constituents. The first N-constituents are defined as before.

Some preferred further N-constituents are defined as above, but are different from the first N-constituents in their chemical constitution and or structure.

Preferred combinations of first and further N-constituents include tri(n-pentyl)amine/tri(n-hexyl)amine, tri(n-pentyl)amine/tri(n-heptyl)amine, tri(n-pentyl)amine/tri(n-octyl)amine, tri(n-pentyl)amine/tri(n-nonyl)amine, tri(n-pentyl)amine/tri(n-decyl)amine and so forth: tri(n-hexyl)amine/tri(n-heptyl)amine, tri(n-hexyl)amine/tri(n-octyl)amine, tri(n-hexyl)amine/tri(n-nonyl)amine, tri(n-hexyl)amine/tri(n-decyl)amine, tri(n-hexyl)amine/tridodecylamine, tri(n-hexyl)amine/trioctadecylamine and so forth; tri(n-heptyl)amine/tri(n-octyl)amine, tri(n-heptyl)amine/tri(n-nonyl)amine, tri(n-heptyl)amine/tri(n-decyl)amine, tri(n-heptyl)amine/tridodecylamine, tri(n-heptyl)amine/trioctadecylamine and so forth; tri(n-octyl)amine/tri(n-nonyl)amine, tri(n-octyl)amine/tri(n-decyl)amine, tri(n-octyl)amine/tridodecylamine, tri(n-octyl)amine/trioctadecylamine and so forth: similarly, combinations with the iso-and branched alkylamines instead of the n-alkylamines are preferred.

Some preferred further N-constituents are defined as before, but have one or more moieties having a carbon chain of length of 4 or less, herein an L-chain.

Some further preferred L-chain moieties are alkyls, e.g. butyl, propyl, and ethyl. Preferred L-chains have 4 or less carbon atoms, for example 1-4 carbon atoms, or 1, 2, 3 or 4 carbon atoms. One preferred further N-constituent is Trimethylamine. One preferred further N-constituent is triethylamine. One preferred further N-constituent is tri(n-propyl)amine. One preferred further N-constituent is tri(n-butyl)amine.

Preferred combinations of first and further N-constituents include trimethylamine/tri(n-pentyl)amine, trimethylamine/tri(n-hexyl)amine, trimethylamine/tri(n-heptyl)amine, trimethylamine/tri(n-octyl)amine, trimethylamine/tri(n-nonyl)amine, trimethylamine/tri(n-decyl)amine and so forth; triethylamine/tri(n-pentyl)amine, triethylamine/tri(n-hexyl)amine, triethylamine/tri(n-heptyl)amine, triethylamine/tri(n-octyl)amine, triethylamine/tri(n-nonyl)amine, triethylamine/tri(n-decyl)amine and so forth; tri(n-propyl)amine/tri(n-pentyl)amine, tri(n-propyl)amine/tri(n-hexyl)amine, tri(n-propyl)amine/tri(n-heptyl)amine, tri(n-propyl)amine/tri(n-octyl) amine, tri(n-propyl)amine/tri(n-nonyl)amine, tri(n-propyl)amine/tri(n-decyl)amine and so forth; tri(n-butyl)amine/tri(n-pentyl)amine, tri(n-butyl)amine/tri(n-hexyl)amine, tri(n-butyl)amine/tri(n-heptyl)amine, tri(n-butyl)amine/tri(n-octyl)amine, tri(n-butyl)amine/tri(n-nonyl)amine, tri(n-butyl)amine/tri(n-decyl)amine and so forth; similarly, combinations with the isoalkylamines instead of the n-alkylamines are preferred.

### A-Bodies

The plurality of A-bodies may be selected from the group consisting of activated carbon; graphite; carbon molecular sieve, iron hydroxides, and one or more polymers.

An A-body comprises one or more polymers. It may be a polymer of a single monomer or a copolymer of more than one different monomers. One preferred polymer is a polystyrene, preferably a polystyrene divinyl benzene copolymer (polystyrene DVB), a polystyrene DVB acrylate, acrylate DVB copolymers, Styrene ethylvinylbenzene (EVB) copolymers or mixed styrene DVB/EVB polymers. Other preferred polymers are acrylates and copolymers of acrylate polymers, e.g. polyacrylonitrils. Another preferred polymer is a methacrylate. Another preferred polymer is a phenol formaldehyde resin. Preferred polymers are hydrophobic.

A preferred embodiment is an A-body which is activated by addition of one or more N-constituents, i.e. a first and optionally further N-constituents, preferably by impregnation or covalent bonding. Preferably, the A-body can be defined like the M-bodies, described with regard to the treatment step. Preferably, the N-constituents of an A-body have one or more moieties having a carbon chain of length of 4 or less, herein an L-chain. Preferably, the length of the carbon chain is 1 or 2.

Some further preferred L-chain moieties are alkyls, e.g. butyl, propyl, and ethyl. Preferred L-chains have 4 or less carbon atoms, for example 1-4 carbon atoms, or 1, 2, 3 or 4 carbon atoms. One preferred further N-constituent is Trimethylamine. One preferred further N-constituent is triethylamine. One preferred further N-constituent is tri(n-propyl)amine. One preferred further N-constituent is tri(n-butyl)amine.

The plurality of A-bodies used in the pre-treatment step can comprise two or more different A-bodies, as described before.

An A-body is preferably porous. An A-body preferably is penetrable by liquid. A preferred A-body has a maximum capacity to soak water up to 10 times its own mass.

An A-body may have pores. Preferred pores are micro pores, meso pores or macro pores. An A-body may have a combination of two or more selected from micro pores, meso pores and macro pores.

One preferred type of A-body is a bead. A bead may be prepared through the agglomeration of smaller particles. A preferred range for the d50 diameter of the A-bodies is from 10 μm to 10 mm, preferably from 50 μm to 5 mm, more preferably from 100 μm to 1 mm. Another preferred range for the d50-diameter is from 0.05 to 1.5 mm.

One preferred type of A-body is a powder. A powder may be prepared by grinding a larger particle, preferably by grinding a bead. A preferred range for the d50 diameter of the A-bodies is from 1 to 200 μm, preferably from 10 to 100 μm, more preferably from 40 to 60 μm or from 40 to 80 μm.

Preferred grinding processes are dry grinding a wet grinding, preferably wet grinding. Grinding may be performed at atmospheric conditions. Grinding may be performed at elevated temperature, or reduced temperature. On preferred grinding is cryogrinding, preferably with liquid nitrogen. One process for reducing the diameter of A-bodies is a homogenisation, preferably with a hammer mill or with a jet mill.

One preferred type of A-bodies has a BET, as determined according to DIN ISO 9277:2003-05, of 300 m²/ or more, for example, 400 m²/g or more, 600 m²/g or more, 800 m²/g or more, or 1000 m²/g or more. The BET of A-bodies can be as high as 2000 m²/g or less; 1600 m²/g or less, 1400 m²/g or less or 1200 m²/g or less.

### Combinations of Bodies Employed in Pre-Treatment and Treatment

A preferred embodiment comprises A-bodies in powder form in the pre-treatment step, and M-bodies in bead form in the treatment step. For example, 80 wt %, 90 wt. % or more of the A-bodies are powder in the pre-treatment step, and 80 wt %, 90 wt % or more of the M-bodies are beads in the treatment step. Often, less than 5 wt %, or less than 2 wt %, or less than 1 wt % of the A-bodies are not powder. Often, less than 5 wt %, or less than 2 wt %, or less than 1 wt % of the M-bodies are not beads.

In a preferred process design, both, the pre-treatment step and the treatment step are operated in two or more distinct treatment vessels. The two or more treatment vessels can be in fluid connection. The vessel comprising the A-bodies is positioned upstream of the vessel comprising the M-bodies. Each vessel has at least a fluid inlet and a fluid outlet. This process design might be beneficial if separate disposal of exhausted A-bodies and M-bodies is planned. A membrane for retaining the a-bodies within the treatment vessel could be arranged between the A-bodies and the outlet of the vessel comprising the A-bodies.

In another preferred process design, both the pre-treatment and the treatment step are operated in a single vessel. In this event, the M-bodies are arranged in the vessel, and A-bodies are arranged upstream from the M-bodies, in fluid direction. This process design might be beneficial if a combined disposal of exhausted A-bodies and M-bodies is planned.

Further, a separating membrane may be arranged between a spatial section in the vessel comprising the M-bodies and another spatial section in the vessel comprising the A-bodies. The purpose of such membrane could be seen in retaining the A-bodies separated from the M-bodies. This process design might be beneficial if separate disposal of exhausted A-bodies and M-bodies is planned.

Preferred embodiments comprise one or more membranes, i.e. an arrangement of membranes, to retain the A-bodies and/or the M-bodies. Examples of a suited membrane is a filter, a fibre sheet, a perforated sheet, a plastic sheet having holes and the like. Combinations of the aforementioned can be employed. In a further preferred variant the one or more vessels which comprise the A-bodies and the M-bodies, or a combination thereof, have a perforation integrated in the vessel, e.g. between a vessels interior and an outlet to the vessel.

At any rate, the perforation, hole diameter or filter fineness should be chosen to be of the same size of or slightly smaller than the size of the A-bodies, and M-bodies respectively, to be retained. The membranes can be part of single use as well as multiple use and/or self-cleaning systems.

At any rate, provided a pre-treatment step is included in the process, a precursor liquid is feed to the pre-treatment step, at the end of which the source liquid is obtained. The source liquid the enters the treatment step, at the end of which a treated liquid is obtained.

In a preferred embodiment, the precursor liquid is aqueous and comprises as X-constituents on or more halogenated organic compounds and B-constituents like NOM and NOM derivatives, while the resulting treated liquid can be selected from drinking water, treated waste water and the like.

In another preferred embodiment, the precursor liquid is aqueous and comprises as X-constituents on or more radionuclides, while the resulting treated liquid has a purity sufficient to dispose the treated liquid in a river or so.

### Preparation of Media

Different methods of preparation of media, the M-bodies, are now described.

### A. Impregnation

One preferred process for preparing the M-bodies is impregnation. Impregnation is preferably performed by soaking R-bodies in a fluid which contains N-constituents. A preferred fluid medium for the N-constituents may be water or an organic solvent. A preferred fluid medium is selected by the skilled person to be suitable for the R-body and the N-constituent. Some preferred fluid mediums are one or more selected form the group consisting of: water, hexane, acetone, dimethyl formamide and methyl formamide.

Impregnation may be performed at ambient temperature or at elevated temperature. The temperature is preferably suited to the fluid medium. Impregnation is preferably performed with stirring or with shaking or both. Impregnation is preferably performed for a period from 10 minutes to 2 days, preferably from 1 hour to 1 day, more preferably from 3 hours to 8 hours.

For a powdered R-body, impregnation may be performed before or after a grinding step, preferably before.

Where impregnation is performed in a non-aqueous fluid medium, a solvent exchange is preferably performed to replace the fluid medium with water.

Where an N-constituent is a gas in the temperature range of 20-100° C., impregnation may be performed at a lower temperature, overpressure or both. Autoclaves are usually well suited to adopt these conditions.

### B. Covalent Bonding

Another preferred process for preparing the M-bodies is covalent bonding, preferably substitution of halogen. Formation of covalent bonds between N-constituents and R-bodies preferably starts from a halogen activated R-body, more preferably a chlorine activated R-body. A preferred chlorination is the Blanc reaction, preferably employing formaldehyde and HCl. Another route to covalent bonds is via an oxirane activated acrylic.

Substitution of N-constituent is preferably performed at elevated temperature, preferably above 80° C., more preferably above 90° C., more preferably above 100° C. A preferred liquid medium for the substitution reaction is dimethylformamide. A preferred concentration for the N-constituent in the liquid medium is 10 to 70 wt. %, preferably 20 to 60 wt. %, more preferably 30 to 50 wt. %. Substitution is preferably performed for 3 to 24 hours, more preferably 5 to 20 hours, more preferably from 8 to 15 hours. Substitution is preferably performed with stirring or shaking or both.

Where an N-constituent is a gas in the temperature range of 20-100° C., the chemical reactions to make the covalent bonding may be performed at a lower temperature, overpressure or both. Autoclaves are usually well suited to adopt these conditions.

### C. Preparation of Mixed Amine Media by Impregnation

A preferred process for preparing the M-bodies is a two-step, repeated impregnation, wherein the first impregnation is done as described in method A.

After having completed the first impregnation, the M-bodies comprising R-bodies soaked with N-constituents are contacted with an amount of an acidic liquid to adjust the pH of the M-bodies.

The acidic liquid can be any aqueous acid solution. A preferred acidic solution is a solution comprising HCl. A preferred solution comprising HCl has a concentration of 5 to 30 wt. HCl, or about 25 wt.-% HCl, or about 10 wt.-% HCl, the rest to 100 wt.-% always being water. Then, the M-bodies are washed with water.

A further impregnation is done with these M-bodies, which are contacted with an amount of a further fluid which contains further N-constituents. Embodiments to this further impregnation are the same as mentioned before for the first impregnation. Once again, the M-bodies can be contacted with an amount of an acidic liquid to adjust the pH of the M-bodies. Same embodiments as before.

A preferred choice for the first impregnation is an N-constituent having one or more moieties having a carbon chain of length at least 5, herein an L-chain, as described above.

A preferred choice for the further impregnation is an N-constituent having one or more moieties having a carbon chain of length at least 5, herein an L-chain, as described above, which is different from the carbon chain used in the first impregnation.

Another preferred choice for the further impregnation is an N-constituent having one or more moieties having a carbon chain of length of 4 or less, e.g. 3, 2 or 1, herein an L-chain, as described above, which is different from the carbon chain used in the first impregnation.

Where an N-constituent is a gas in the temperature range of 20 to 100° C., impregnation may be performed at a lower temperature, overpressure or both. Autoclaves are usually well suited to adopt these conditions.

### D. Preparation of Mixed Amine Media by Covalent Bonding in Two Steps

Another preferred process for preparing the M-bodies is covalent bonding, preferably substitution of halogen. Formation of covalent bonds between N-constituents and R-bodies preferably starts from a halogen activated R-body, more preferably a chlorine activated R-body. A preferred chlorination is the Blanc reaction, preferably employing formaldehyde and HCl. Another route to covalent bonds is via an oxirane activated acrylic.

In this embodiment, substitution with two different N-constituents is done. This can be carried out simultaneously, employing a mix of two or more N-constituents. Another, yet preferred option is to carry out two or more substitution reactions in a sequence. A step of pH-adjustment and washing can be an intermediate.

Substitution of a first N-constituent is preferably performed at elevated temperature, preferably above 80° C., more preferably above 90° C., more preferably above 100° C. A preferred liquid medium for the substitution reaction is dimethylformamide. A preferred concentration for the first N-constituent in the liquid medium is 10 to 70 wt. %, preferably 20 to 60 wt. %, more preferably 30 to 50 wt. %. Substitution is preferably performed for 3 to 24 hours, more preferably 5 to 20 hours, more preferably from 8 to 15 hours. Substitution is preferably performed with stirring or shaking or both.

Where an N-constituent is a gas in the temperature range of 20-100° C., the chemical reactions to make the covalent bonding may be performed at a lower temperature, overpressure or both. Autoclaves are usually well suited to adopt these conditions.

After having carried out the first substitution, the M-bodies comprising R-bodies soaked with N-constituents are contacted with an amount of an acidic liquid to adjust the pH of the M-bodies. The acidic liquid can be any aqueous acid solution.

A preferred acidic solution is a solution comprising HCl. A preferred solution with HCl has a concentration of 5 to 30 wt. HCl, or about 25 wt.-% HCl, or about 10 wt.-% HCl, the rest to 100 wt.-% always being water. Then, the M-bodies are washed with water.

Substitution of a further N-constituent, which differs from the first N-constituent, is preferably performed at elevated temperature, preferably above 80° C., more preferably above 90° C., more preferably above 100° C. A preferred liquid medium for the substitution reaction is dimethylformamide.

Where an N-constituent is a gas in the temperature range of 20-100° C., the chemical reactions to make the covalent bonding may be performed at a lower temperature, overpressure or both. Autoclaves are usually well suited to adopt these conditions.

A preferred concentration for the further N-constituent in the liquid medium is 10 to 70 wt. %, preferably 20 to 60 wt. %, more preferably 30 to 50 wt. %. Substitution is preferably performed for 3 to 24 hours, more preferably 5 to 20 hours, more preferably from 8 to 15 hours. Substitution is preferably performed with stirring or shaking or both.

A preferred choice for the first impregnation is an N-constituent having one or more moieties having a carbon chain of length at least 5, herein an L-chain, as described above.

A preferred choice for the further impregnation is an N-constituent having one or more moieties having a carbon chain of length at least 5, herein an L-chain, as described above, which is different from the carbon chain used in the first impregnation.

Another preferred choice for the further impregnation is an N-constituent having one or more moieties having a carbon chain of length of 4 or less, e.g. 3, 2 or 1, herein an L-chain, as described above, which is different from the carbon chain used in the first impregnation.

Preferred M-bodies can have first and further N-constituents in a ratio from 1:20 to 20:1, for example 1:15 to 15:1, or 1:10 to 10:1, or 1:4 to 4:1, or 2:3 to 3:2, or about 1:1.

### E. Preparation of Mixes of Different Amine Media

A combination of different species of M-bodies, a first and further species of M-bodies, are provided. Each species of M-bodies comprises at least one N-constituent and can be obtained by according to the methods A through D. Preferred species of M-bodies can be these:

| Class of species of | |
|---|---|
| M-bodies | Description |
| S1 | N-constituents with L-chains |
| | having C chain of length ≥5 |
| S2 | N-constituents with L-chains |
| | having C chain of length <5 |
| S3 | Two different N-constituents with L-chains |
| | having C chain of length ≥5 |
| S4 | Two different N-constituents with L-chains |
| | having C chain of length <5 |
| S5 | Two different N-constituents with L-chains, |
| | first N-constituents with L-chains having C |
| | chain of length ≥5, further N-constituents |
| | with L-chains having C chain of length <5. |
| S6 | Two different N-constituents with L-chains, |
| | both N-constituents with L-chains having |
| | C chain of length <5. |

Preferred mixes of species of M-bodies are, amongst others: S1S1*, S1S2, S1S3, S1S4, S1S5, S1S6, S3S3*, S3S4, S3S5, S3S6, S5S5* and S5S6. A species marked with an asterix (*) in this list describes that this species of M-bodies belongs to the same class of species but is different from the species not being marked with an asterix (*). A preferred mix of a first and a further species of M-bodies can in a ratio from 1:20 to 20:1, for example 1:15 to 15:1, or 1:10 to 10:1, or 1:4 to 4:1, or 2:3 to 3:2, or about 1:1.

A further preferred M-bodies' mix comprises three or more of different species of M-bodies.

Regarding all further steps and uses such as drying, solvent exchange and housing, a mix of different M-bodies is also referred to as “the M-body”.

### III. Drying

In one embodiment of the invention, the M-body is dried to reduce its water content. One preferred drying method is infrared drying. Another preferred drying is performed at reduced pressure.

### IV. Solvent Exchange

In one preferred preparation, a solvent exchange step is performed. A solvent exchange step might be particularly preferred where N-constituents are introduced to R-bodies in a nonaqueous solvent, such as an organic solvent.

### Housing

A housing is a device which hosts the exchange media (M-bodies) and through which the liquid is flushed. A housing may have one or more inlets, one or more outlets, and possibly further connects for liquid exchange and/or sensors. The housings can be made of a variety of materials, such as glass, plastic and/or metal. A housing may also comprise parts made of different materials, e.g. a part of glass, others of metal.

### FIGURES

FIG. 1 shows a schematic representation of the process of the invention.

FIG. 2 shows a schematic sample experimental setup.

### BRIEF DESCRIPTION OF THE FIGURES

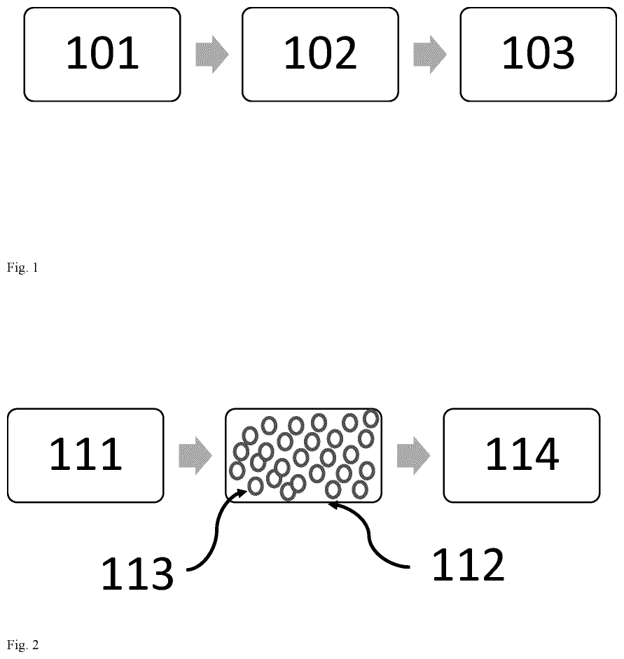

FIG. 1 shows a schematic representation of the process for preparing a treated liquid. The treatment process comprises at least these steps: 101 providing a source liquid, 102 providing a plurality of solid ion exchange media, e.g. M-bodies, 103 contacting the source liquid with the plurality of solid ion exchange media.

FIG. 2 shows a schematic sample experimental setup. A source liquid 111 is fed into a column 112, in which beads 113 of ion exchange media are stacked. A treated liquid 114 leaves the column 112.

### EXAMPLES

### I. Impregnation

### 1. Preparation of CTAC Activated Ion Exchange Media

5 g of a porous polystyrene polymer (Treverlite 510IXA in chloride form available from Chemra GmbH) were shaken in 50 ml of a 25 wt. % aqueous solution of cetyltrimethylammonium chloride for 8 hours. It was then washed with water. The preparation process was repeated except with a 25 wt. % aqueous solution of tri(n-octyl)amine.

### 2. Preparation of Tri(n-octyl)Amine Activated Ion Exchange Resin

1 g of porous polystyrene polymer (Treversorb ADS 500 available from Chemra GmbH) was washed with water, acetone and n-hexane. The gel was shaken for 8 hours with a 30% solution of tri(n-octyl)amine in hexane. It was then washed with acetone and water. Successful adsorption of the amine was demonstrated by elemental analysis.

| Gel | N content in wt. % |
|---|---|
| Unactivated Treversorb ADS 500 | 1.3 |
| Treversorb ADS 500 activated | 2.7 |
| with tri(n-Octyl)amine | |

### 3. Determining Adsorption Capacity for Nonafluoro Butane Sulphonic Acid (PFAS)

1 g of the medium dried to constant mass was shaken in 25 ml of 0.2 M aqueous solution of nonafluoro butane sulphonic acid (Aldrich, MW=300 g/mol) for 8 hours. The residual concentration of the nonafluoro butane sulphonic acid in the water solution was then determined by titration with 0.1 M NaOH. The adsorbed quantity of PFAS was determined as the difference.

### 4. Results

In both cases, the capacity for PFAS adsorption was increased significantly in comparison to an unactivated ion exchange resin.

In both cases, the activated polymer resin had a capacity significantly greater than an analogous activated porous carbon species prepared according to the method disclosed in WO 2020/037061 A1.

### II Covalent Bonding

### 1. Chloromethylation of PS-DVB Copolymers with 2 Weight Percent of DVB

A mixture of paraformaldehyde (20 g) and 1,4-butandiol (30 g) in a flask was cooled to about 7°° C. in a cold water bath, and hydrogen chloride gas was passed into the flask for 7 h. Then the mixture was then chilled to 0° C. during overnight, and it separated into two layers. The upper layer was collected, dried over magnesium sulfate and distilled in vacuum to yield 1,4-bis (chloromethoxy) butane.

To a stirred suspension of 1.04 g (0.01) of polystyrene-2% divinylbenzene (Supelco 434442, Merck KgAA) and 3.74 g (0.02 mol) of the 1,4-bis (chloromethoxy) butane in 20 ml of dichloromethane was slowly added 0.05 ml (0.004 mol) of stannic chloride at 0° C. The reaction mixture was stirred at room temperature for 18 h. The mixture was then cooled to 0° C. and treated with 15 ml of 1N hydrochloric acid. The polymer beads were recovered by filtration, washed with water-dioxane, dioxane, methanol and dichloromethane. The beads were dried overnight in vacuum at room temperature.

### 2. Amination with a Tertiary Amine (NR₃), e.g. Trioctylamine

The reaction was carried out in a double-walled three-neck round-bottom flask (500 ml) with intensive cooler on the middle neck. The cooler was attached to water cooling and the upper outlet to argon supply. On a side neck, a dropping funnel with gas compensation was attached. The third neck was used to insert a thermometer into the media to record temperatures. The double-wall of the round-bottom flask was connected to a thermostat which purged oil through to adjust the temperature in the round-bottom flask. A Teflon coated magnet was put in the round bottom-flask, which sits on a magnetic stirrer. The apparatus was flushed with argon prior to use.

100 g of chlorinated polymeric ion exchange material from step 1. And 200 ml dichloromethane were placed inside the round-bottom flask and cooled to a temperature of 10-15° C. 150 ml of 1:2 (Vol./Vol.) mixture of tri (n-octyl) amine (CAS no. 1116-76-3) and dichloromethane were added dropwise under stirring within 1 hour using the dropping funnel while maintaining a temperature of 10-15° C. and the resulting mixture was stirred and refluxed over night. Then, the content of the round-bottom flask was poured on a glass frit (type MN85/90, 0.45 μm, Macherey & Nagel), by which the modified ion exchange material was separated from the liquid phase. The modified ion exchange material (solid remainder in the frit) was washed three times with 300 ml of 2 mol/l HCl, and further three times with 300 ml of aqua dest. Then, the modified ion exchange material was washed with i-propanol, methanol and acetone, 200 ml each, and dried in a dry box in vacuo at 50° C. for 12 hours.

### 3. Determination of Exchange Capacity

Charging of a separation column with 60 ml of a 0.2 mol/kg HCl solution, washing with 60 ml aqua dest., eluating of chloride with 60 ml of a 0.2 mol/kg NaNO₃-solution; adding 1 mL of 6 Mol/kg HNO₃ to the eluate. Potentiometric titration of Cl with 0.05 mol/kg AgNO₃ against a Calomel-electrode (Ag/AgCl electrode); each capacity was measured three times. The capacity is given in μMol/column and in μMol/mL volume of the column.

### 4. Mixed Amination

First, amination was conducted as in point 2. above. Then, a second amination was conducted as before, however, a 1:2 (Vol./Vol.) mixture of tri (n-propyl) amine (CAS no. 102-69-2) and dichloromethane was applied as above. The further procedure remained unchanged.

### 5. Results

In all cases, the capacity for PFAS adsorption was increased significantly in comparison to an unactivated ion exchange resin.

In all cases, the activated polymer resin had a capacity significantly greater than an analogous activated porous carbon species prepared according to the method disclosed in WO 2020/037061 A1.

1-34. (canceled)

35. A treatment process for preparing a treated liquid, the treatment process comprising:
a. providing a source liquid, the source liquid comprising:
i. water at a content of at least 70 wt. %, and
ii. one or more X-constituents at a total content of at least 10-10 wt. %, each X-constituent being a halogenated organic compound having 2 or more halogen atoms per molecular unit, or each X-constituent being a complex ion comprising at least one radionuclide;
b. providing a plurality of solid M-bodies, each M-body comprising:
i. an R-body of one or more R-constituents at a dry weight total content of at least 80 wt. %, each R-constituent being a polymer,
ii. first and further N-constituents adjacent to the R-body at a total dry weight content in the range from 0.1 to 10 wt. %, each N-constituent comprising an N atom present as an amine or an ammonium;
iii. water at a content of up to 90 wt. %, based on the total weight of the M-body;
c. contacting the source liquid with the plurality of M-bodies to obtain the treated liquid, the treated liquid having a lower total content of X-constituents than the source liquid,
wherein at least the first N-constituents have one or more L-chains connected to the N atom, each L-chain having a C chain of length 5 or more.

36. The process of claim 35, wherein there is one or more covalent bonds between the R-bodies and the N-constituents.

37. The process of claim 35, wherein there is one or more non-covalent bonds between the R-bodies and the N-constituents.

38. The process of claim 35, wherein one or more of the X-constituents is an X*-constituent, each X*-constituent having 20 carbon atoms or less per molecular unit and wherein the total content of X*-constituents in the treated liquid is less than the total content of X*-constituents in the source liquid.

39. The process according to claim 35, wherein one or more of the R-bodies is a gel body.

40. The process according to claim 35 wherein one or more of the X-constituents comprises at least one of these elements: one or more F atoms per molecule, one or more Cl atoms, one or more perhalogen moieties and at least a chemical complex comprising a radionuclide.

41. The process of claim 35, wherein the plurality of M-bodies satisfies one or more of the following criteria:
a. A d₅₀ for M-body diameter in the range from 10 μm up to 10 mm or in the range from 1 to 200 μm;
b. A d₅₀ for pore size in the range from 1 nm to 10⁴ nm; and
c. A moisture holding capacity in the range from 20 to 90%, being the maximum content of water based on the total weight of the wet body.

42. The process of claim 35, wherein one or more of the plurality of M-bodies is obtainable by a preparation process comprising the following preparation process steps:
a. providing a plurality of R-bodies;
b. providing a fluid comprising one or more N-constituents; and
c. contacting the plurality of R-bodies with the fluid to obtain the plurality of M-bodies;
wherein the plurality of M-bodies has a greater total content of N-constituents than the plurality of R-bodies.

43. The process of claim 35, wherein the treatment process comprises a step of adding the plurality of M-bodies to the source liquid.

44. The process of claim 35, wherein the plurality of M-bodies are contained in a module and the treatment process comprises the following steps:
a. introducing the source liquid into the module before the contacting step; and
b. the treated liquid exits the module after the contacting step.

45. The process of claim 35, wherein the further N-constituents have one or more L-chains connected to the N atom, wherein the further N-constituents are different from the first N-constituents.

46. The process of claim 35, wherein one of the following applies:
A/ each L-chain of the further N-constituents has a C chain of length 5 or more; or
B/ each L-chain of the further N-constituents has a C chain of length of 4 or less.

47. The process of claim 35, wherein the plurality of solid M-bodies comprises at least two species of M-bodies, which are a first and a further species, wherein the first and further species of M-bodies are different from each other.

48. The process of claim 35 wherein a pre-treatment is conducted before step a., at least comprising these steps:
A) providing a precursor liquid comprising:
I) water,
II) one or more X-constituents, each X-constituent being a halogenated organic compound having 2 or more halogen atoms per molecular unit, or each X-constituent being a complex ion comprising at least one radionuclide;
III) one or more B-constituents;
B) providing a plurality of solid A-bodies, each A-body being an element selected from the group selected from activated carbon; graphite; carbon molecular sieve, iron hydroxides and polymers.
C) contacting the precursor liquid with the plurality of A-bodies to obtain the source liquid, the source liquid having a lower amount of B-constituents than the precursor liquid.

49. A water treatment plant comprising a plurality of M-bodies, which comprise a first and further M-bodies, each M-body comprising:
a. one or more R-constituents at a total dry weight content of at least 80 wt. %, each R-constituent being a polymer;
b. first and further N-constituents adjacent to the R-body at a total dry weight content in the range from 0.1 to 10 wt. %, each N-constituent comprising an N atom present as an amine or an ammonium; and
c. water at a content of up to 90 wt. %, based on the total weight of the M-body
wherein at least the first N-constituents have one or more L-chains connected to the amino nitrogen, each L-chain having a C chain of length 5 or more.

50. The water treatment plant of claim 49, further comprising a plurality of A-bodies, each A-body comprising at least one of element of the group selected from activated carbon; graphite; carbon molecular sieve, iron hydroxides, and one or more polymers.

51. The water treatment plant of claim 49, wherein the A-bodies are positioned upstream from the M-bodies with respect to the flow direction of fluid in the plant.

52. A use of a plurality of M-bodies for water treatment, each M-body comprising:
a. one or more R-constituents at a total dry weight content of at least 80 wt. %, each R-constituent being a polymer;
b. first and further N-constituents adjacent to the R-body at a total dry weight content in the range from 0.1 to 10 wt. %, each N-constituent comprising an N atom present as an amine or an ammonium; and
c. water at a content of up to 90 wt. %, based on the total weight of the M-body
wherein at least the first N-constituents have one or more L-chains connected to the amino nitrogen, each L-chain having a C chain of length 5 or more.

53. A use of a plurality of M-bodies for reducing the total content of X-constituents in a liquid, each M-body comprising:
a. one or more R-constituents at a total dry weight content of at least 80 wt. %, each R-constituent being a polymer;
b. first and further N-constituents adjacent to the R-body at a total dry weight content in the range from 0.1 to 10 wt. %, each N-constituent comprising an N atom present as an amine or an ammonium; and
c. water at a content of up to 90 wt. %, based on the total weight of the M-body
wherein at least the first N-constituents have one or more L-chains connected to the amino nitrogen, each L-chain having a C chain of length 5 or more.

54. A use of a plurality of M-bodies for reducing the total content of radionuclides in a liquid, each M-body comprising:
a. one or more R-constituents at a total dry weight content of at least 80 wt. %, each R-constituent being a polymer;
b. first and further N-constituents adjacent to the R-body at a total dry weight content in the range from 0.1 to 10 wt. %, each N-constituent comprising an N atom present as an amine or an ammonium; and
c. water at a content of up to 90 wt. %, based on the total weight of the M-body
wherein at least the first N-constituents have one or more L-chains connected to the amino nitrogen, each L-chain having a C chain of length 5 or more.

55. The use according to at least one of claim 52 in combination with a plurality of A-bodies, wherein the A-bodies are upstream from the M-bodies, each A-body being an element selected from the group selected from activated carbon; graphite; carbon molecular sieve, iron hydroxides, and one or more polymers.
